(19) United States
(12) Patent Application Publication
(10) Pub. No.: US 2004/0125932 A1
(43) Pub. Date: Jul. 1, 2004

(54) Conference calls augmented by visual information

(75) Inventors: Mordechay Orbach, Nesher (IL); Amnon Ribak, Misgav (IL); Eishay Smith, Hamovil (IL); Pnina Vortman, Haifa (IL)

Correspondence Address: Stephen C. Kaufman, Intellectual Property Law Dept., IBM Corporation, P.O. Box 218, Yorktown Heights, NY, 10598, US

(73) Assignee: International Business Machines Corporation, Armonk, NY

(21) Appl. No.: 10/331,448

(22) Filed: Dec. 27, 2002

(51) Int. Cl. H04M 3/42

(52) U.S. Cl. 379/202.01

(57) ABSTRACT

A method of deploying a teleconference system, including the steps of during a teleconference, receiving a multiplicity of events from a telephone switch communicating via a plurality of phone lines with a plurality of calling devices, and sending messages pertaining to the events to a plurality of displays, wherein each of the displays is associated with one of the calling devices.

### FIELD OF THE INVENTION

The present invention relates to teleconferences in general, and more particuarly to provision of visual information for teleconferences.

### BACKGROUND

Telephone conference calls, otherwise known as teleconferences, have become one of the industry's main channels for working in virtual teams. Teleconferences enable joint work between remote teams, global international companies and mobile workers. However, teleconferences are still not as effective as face-to-face meetings.

As an example, in teleconferencing it is difficult identify the presence of other invited participants. Additionally, the participants may not know the other participants, their affiliation, job titles and responsibilities in the organization.

Furthermore, unless the listener is familiar with the speaker, it is difficult to identify the identity of the current speaker. Likewise, it is hard to keep track of “who said what”, “who presented what”, and the general dynamics of the teleconference.

All this may cause misunderstanding and confusion. To compound these difficulties, telephone communication does not provide the participants with visual aids such as body language, facial expression and other nonverbal information. Hence, participants may miss the full meaning of the message being conveyed.

Furthermore, for important teleconferences, it may be imperative to archive the conference such that each part of the teleconference is associated with the applicable speaker. Such capabilities are not available in prior art teleconferences.

Videoconferencing compensates for many of these difficulties. However, videoconferencing has several drawbacks, such as long delays, poor image quality, expensive and complicated setting. These drawbacks restrict widespread use of the technology.

Another solution is information Technology (IT) based solutions, such as Microsoft Netmeeting™ an Lotus Sametime™. While solving some of the problems, these technologies do not provide a complete solution. In particular they do not offer support to mobile workers that rely mostly on handheld devices and cellular phones.

### SUMMARY

It is an objective of the present invention to augment teleconferences with visual information. The visual information may be presented on computer monitors, on the displays of handheld devices, or on cellular phones displays.

The presented information may include, among other things, a list of participants, currently attendees, current speaker, current topic, agenda of the call, etc. The present invention may provide rich contextual knowledge not offered in prior art

According to one embodiment of the present invention, there is therefore provided a teleconferencing system for a teleconference. The system includes a service and a conference information center. The service receives a multiplicity of events via a telephone switch. The telephone switch communicates via a plurality of phone lines with a plurality of calling devices. The conference information center receives the events from the service, and sends messages pertaining to the events to a plurality of display, wherein each display is associated with one of the calling devices.

The events may include call member joined teleconference, call member left teleconference, call member speaking, call member is dominant speaker, change of topic, schedule change, or request to be speaker.

The present embodiment may include a conferencing bridge in communication with the telephone switch. The conferencing bridge maps each of the plurality of phone lines to an associated call leg. When an event happens on one of the phone lines, the conferencing bridge associates the event with one of the call legs and notifies the service of the event and associated call leg. The invention may also include a voice activity device (VAD). The VAD detects voice activity, associates the activity with one of the plurality of telephone lines, and notifies the conference bridge of the activity and the associated phone line.

The present embodiment may further include a participant identification module and a participant device mapping module in communication with the service. The participant identification module associates each of a plurality of users with one of the plurality of phone lines. The participant device mapping module maps the plurality of calling devices. Upon notification of an event, the service associates the event with a user, and notifies the conference information center of the event and the associated user.

The conference information center may include conference information, wherein the conference center sends text messages pertaining to the conference information to the displays. The conference information may include invitees name; invitee affiliation; invitee job title; invitee static picture; invitee video image; status of invitees—missing, attending, speaking, presenting, mediating; agenda; title of topics; planned duration of topics; actual duration of topics; presenter of topic; topic supporting material; topic decisions; speakers list; past, present and future speakers; current speaker; text messages may be created by the users during the teleconference; type of message, author of message, and audience to whom message was sent.

The present embodiment may include a recorder for recording the teleconference. The recorder in communication with the service, the service for associating periods of the recording with events, and for allowing replay of the recording according to the associated events.

The plurality of calling devices may includes a messaging module, such that during the teleconference, the messaging module sends messages to one or more other the calling devices. The system may also include a dominant speaker detector in communication with one of the calling devices. The dominant speaker detector detects a dominant speaker among two or more speakers using the calling device, and notifies the service who is the dominant speaker.

According to another embodiment of the present invention, there is therefore provided a method for teleconferencing. The method includes during a teleconference, receiving a multiplicity of events from a telephone switch communicating via a plurality of phone lines with a plurality of calling devices. The method further includes sending messages pertaining to the events to a plurality of displays, each the display associated with one of the calling devices.

The embodiment may further include mapping each of the plurality of phone lines with an associated call leg, and upon occurrence of an event on one of the phone lines, associating the event with its associated call leg. Further steps may include associating each of a plurality of users with one of the plurality of phone lines, mapping each of the calling device, and upon notification of an event, notifying the plurality of users of the event and the user associated with the event.

The present embodiment may also include storing conference information, and sending text messages pertaining to the conference information to the displays. Next steps may includes recording the teleconference, associating periods of the recording with events, and replaying of the recording with the associated events.

The present embodiment may also include sending data notifications via IP to the calling devices includes GPRS capabilities, and displaying on the display associated with the plurality of calling devices a graphical view of speakers and associated period of presentation.

According to one embodiment of the present invention, there is therefore provided a method for displaying participants in a teleconference. The method includes the steps of displaying at least a dynamic list of names of the participants, and when one of the participants is speaking, indicating that the one participant is currently speaking. The step of indicating includes the step of displaying the name of the speaking participant at the top of the list.

According to one embodiment of the present invention, there is therefore provided a teleconference lifeline, wherein the lifeline includes a dynamic list of names of the participants in a teleconference, wherein the name of the current speaking participant is listed at the top of the list.

According to one embodiment of the present invention, there is therefore provided a computer program embodied on a computer-readable medium. The computer program includes a first code segment operative to receive a multiplicity of events via a telephone switch communicating via a plurality of phone lines with a plurality of calling devices. A second code segment is operative to receive the events and send messages pertaining to the events to a plurality of displays, each the display associated with one of the calling devices. A third code segment is operative to associate each of a plurality of users with one of the plurality of phone lines.

A fourth code segment is operative to map the plurality of calling devices and upon notification of an event. A fifth code segment operative to associate the event with a user, and notify the second code segment of the event and the associated user.

According to one embodiment of the present invention, there is therefore provided a method of deploying a teleconference system. The method of deploying includes the steps of during a teleconference, receiving a multiplicity of events from a telephone switch communicating via a plurality of phone lines with a plurality of calling devices, and sending messages pertaining to the events to a plurality of displays, wherein each the display is associated with one of the calling devices.

### BRIEF DESCRIPTION OF THE DRAWINGS

The present invention will be more fully understood from the following detailed description of embodiments thereof, taken together with the drawings in which:

FIG. 1 is a block diagram illustrating components of an augmented teleconferencing system, operated and constructed according to a preferred embodiment of the present invention; and

FIG. 2 is an illustration of a lifetime diagram, constructed according to a preferred embodiment of the present invention.

### DETAILED DESCRIPTION

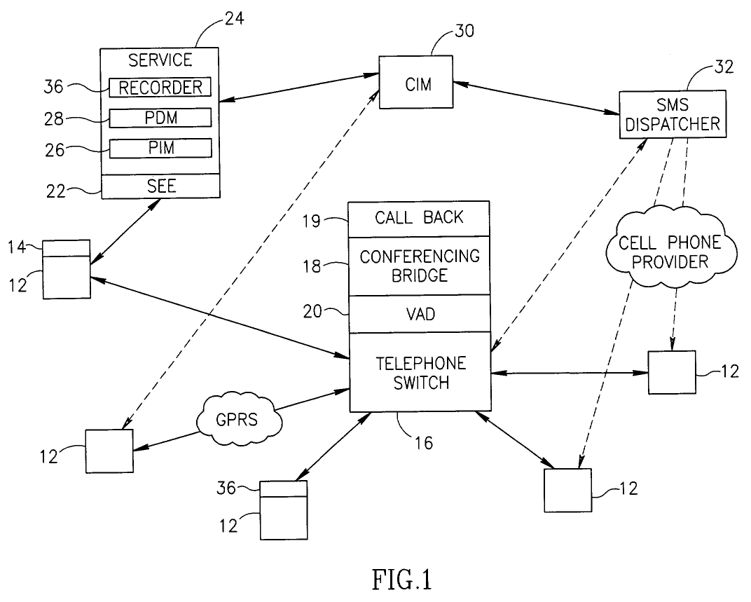

Reference is now made to FIG. 1, a block illustration of system 10, an augmented teleconferencing system, operated and constructed according to a preferred embodiment of the present invention.

System 10 may provide a complete and coherent solution to the problems described in the Background. System 10 may provide the solution via use of existing data channels, such as Short Message Service (SMS), Wireless Application Protocol (WAP) or Transmission Control Protocol/Internet Protocol TCP/IP based protocols and visual displays of mobile and other devices.

System 10 uses events from telephony switches to detect when participants join or leave the call, and when they speak. System 10 similarly uses events sent by users and their applications to detect the same information.

System 10 may comprise a conference information manager 30 to store and distribute information about the meeting. The devices associated with the different call members may present the information based on the capabilities of the device, and user preferences.

System 10 may comprise a plurality of conference call members 12, a conferencing bridge 18, a voice activity detector (VAD) 20, a teleconferencing service 24, and a conference information manager 30.

Call members 12 may be cell phone users with SMS or WAP capacities, telephone users with smart telephone capabilities, and/or telephone users with computers. Call members 12 may additionally comprise cell phone users with hand held devices with SMS capabilities. The above list is meant to be illustrative of the possible call members 12, while not limiting the complete options to the above list. Other possible options for call members 12 are included within the true spirit and scope of this invention.

In an optional preferred embodiment, two or more call members 12 may be connecting to system 10 on the same call-leg, i.e. on a shared phone in a conference room. In these cases, system 10 may comprise a dominant speaker detector 14. Dominant speaker detector 14 is typically installed in the conference room. Dominant speaker detector 14 identifies the dominant speaker and send this information a service execution environment (SEE) 22.

In order to identify the dominant speaker, in one embodiment, dominant speaker detector 14 may comprise a microphone and multiple active badges (not shown), one for each person in the room. Via the active badges, dominate speaker detector 14 “knows” where the is badge is located, and hence where each person is sitting. The microphone then detects where the dominant voice is coming from.

In an alternative solution, each person participating in the conference call may have an active device comprising a small microphone. When the microphone detects that the associated user is speaking, the active device notifies dominant speaker detector 14. Alternatively, the active device may transmit the voice level, but not the actual speaking to dominate speaker detector 14. Dominant speaker detector 14 then decides who the dominant speaker is, and send this information to SEE 22.

It is noted that although not listed herein, there are numerous methods and apparatus to perform the functions of dominate speaker detector 14. Such methods and apparatus, although not listed, fall within the scope and principles of the present invention.

Conferencing bridge 18 may sit on a telephony switch 16. Telephone switch 16 may comprise a plurality of telephone lines. Some of the telephone lines may be “cordless” telephone lines.

Conferencing bridge 18 may be a centralized and may enable multipoint control unit (MCU) features for media mixing on multiparty calls. Each telephone line may be mapped to a call leg at conferencing bridge 18. When an event occurs on a call leg, such as “user started speaking”, conferencing bridge 18 sends this information to SEE 22.

In preferred embodiments, conferencing bridge 18 may comprise a callback service 19. Callback 19 may provide the ability to reserve a conference at a specific time. Callback 19 may enable conferencing bridge 18 to telephone call members 12 at a specific time. Callback 19 may additionally enable conferencing bridge 18 to notify and remind the call members 12 of a teleconference.

In preferred embodiments of the present invention VAD 20 may also sit on telephony switch 16. When there is voice activity on more then one leg, VAD 20 may determine the dominant speaker. VAD 20 may work in a self-detection mode, when possible. In alternative embodiments, as noted above, dominant speaker detector 14 may identify the dominant speaker.

Service 24 may sit on SEE 22. SEE 22 may receive call information from a telephony switch 20. SEE 22 may also connect to the Internet. Information received by SEE 22 may be delivered to service 24.

Service 24 may comprise a participant identification module (PIM) 26 and a participate device mapping (PDM) 28.

Participant identification module 26 may comprise a list of invitees, and mapping from the call-legs to call members 12. Via the mapping, system 10 may detect events such as ‘user joined’, ‘user left’ and/or ‘user speaking’.

Participant device mapping 28 may comprise a list of call members 12 and their associated calling devices. Participant device mapping 28 may additionally comprise the capabilities and address of the associated calling devices. Participant device mapping 28 may send this information and events to the conference information manager 30.

Conference information manager 30 may store and update the conference status, and send status updates to the associated calling devices of call members 12. Changes in the status of the teleconference, such as ‘topic started’ ‘user x sent message y to users z’ will arrive at conference information manager 30. Conference information manager 30 may then store this information and distribute it to the call members 12.

It is noted that in alternative embodiments, conference information manager 30, rather than service 24, may comprise participant identification module 26 and participant device mapping 28. Additionally, although represented herein as two elements, participant identification module 26 and participant device mapping 28 may be joined into one element.

Conference information manager 30 may communicate with an SMS dispatcher 32. SMS dispatcher 32 may connect to the Internet and may have the ability to send SMS messages to and from the Internet. SMS dispatcher 32 may additionally send SMS messages via a cellular phone provider switch.

System 10 may additionally communicate with a general packet radio service (GPRS) provider 34. GPRS provider 34 may exchange data information in addition to voice and take advantage of the capabilities of the display.

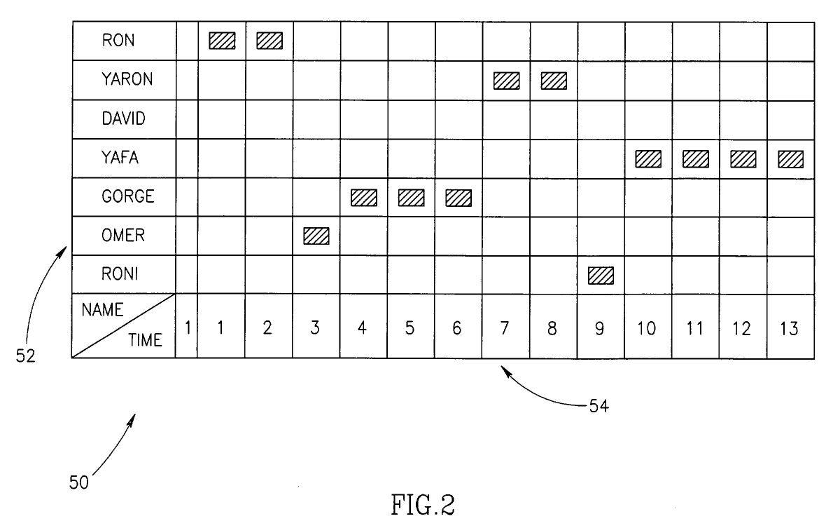

In preferred embodiments of the present invention, system 10 may comprise a recorder 36. Recorder 36 may sit at either a call member 12 with a smart phone or on SEE 22. Recorder 36 may associate each recording frame with the current speaker. Detailed explanation of the recording and playback process will be described hereinbelow in reference to FIG. 2.

The operation and functioning of system 10 will now be explained.

When setting up the teleconference, one of the call members 12, or any other person, may provide initial information to conference information manager 30. The initial information may comprise typical teleconference information, such as date, time, and conference number, as well as agenda details and the personal details of the call members 12.

In some embodiments, conference information manager 30 may be in communication with a corporate database (not shown). The corporate database may provide the personal details of each call member 12, thus eliminating the need to provide such information manually. Conference information manager 30 may store this information.

When a new call member 12 connects to the teleconference, telephony switch 16 is aware of this information. Telephony switch 16 may send the port and caller identification of new call member 12 to SEE 22. In preferred embodiments, SEE 22 may provide service 24 with low-level events detected by the telephony switches 16. In alternative embodiments, SEE 22 may provide higher-level events to service 22, or directly to conference information manager 30.

As noted above, service 24 holds the information on call members 12, their associated ports/legs, and mapping of their names and caller ids. Service 24 may pass the event, e.g. “New user”, to the conference information manager 30.

Conference information manager 30 updates the list of call members 12 in the teleconference. Conference information manager 30 may then send an event message to call members 12 notifying them of the new call member status. The event message may be sent over IP-line, as an SMS message or as a WAP-push message

In preferred embodiments of the present invention, the call members 12 may receive at least a subset of a Conference Information Structure that is represented in Extendable Markup Language (XML). The form of the conference XML-based information may be determined according to the capabilities of the call member's associated calling device. Examples of conference XML-based information are listed hereinbelow. In some cases, the XML-based structure may be mapped to another format before sending it. For example, if the associated calling device is SMS-enabled only, an SMS message may be sent with a list of all attending call members 12.

In alternative embodiments, according to the capabilities of the associated device, call members 12 may request to view further information about the teleconference. As an example, call members 12 may request to receive detailed information about a particular call member 12, the speakers' list, or see the list of topics.

During the teleconference, call member 12 may send a text or multimedia message to any subset of the participant list. Service 24 assists in passing some of those messages as SMS or Multimedia Messaging System (MMS) messages, while others may use WAP or the TCP/IP channel. Call member 12 may define the context of the message, i.e. the current topic, ‘general’, ‘gossip’, undefined, and so on. The message may then be stored according to the defined context.

In a preferred embodiment system 10 may be a disciplined environment. In such cases, system 10 may give call members 12 a “speaker” role. Call member 12 may then send a dual tone multi-frequency (DTMF) message when he wants to speak. Conferencing bridge 18 may receive the DTMF message, and send the request to speak to SEE 22.

SEE 22 may inform service 24 of the request, who in turn may inform conference information manager 30. Alternatively, SEE may directly inform conference information manager 30. Conference information manager 30 may then send a ‘speaker-changed’ event with the speaker's name to call members 12.

Alternatively, in a non-disciplined environment, one of the call members 12 may start to speak. VAD 20 may detect voice activity, and via dominant speaker algorithms identify the dominant speaker. This information is passed to service 24 and conference information manager 30. Conference information manager 30 may send to call members 12 a ‘speaker-changed’ event with the speaker's name.

In preferred embodiments of the present invention, a conference moderator or another user may manually enter some changes to system 10. Examples of such changes may include, inter alia, ending one topic and starting the other. These events may be sent to call members 12 in the same manner as described above.

Reference is now made to the below example of conference XML-based information. During the teleconference, and according to the capabilities of their associated calling device, call members 12 may navigate through the XML-based information.

Invitees' For each invitee any subset of the following:

Name

Affiliation

Job title

Picture

a. Static; a picture taken from archive, or

b. Current; from a video or a still-image source currently operational

Status (missing, attending, speaking, presenting, mediating, etc.)

Agenda; Topic list, and for each topic any subset of the following:

Title

Duration

Planned

Actual

Type; discussion, presentation, review, etc.

Presenter

Supporting Material

Decisions

Speakers List

A sequential list of the speakers in the teleconference, past, present and future. As an example, the list may comprise call members 12 waiting to speak, and the order in which they are invited to speak. For each past speaker, the start and end time of their speaking period may be kept.

The current speaker—a quick access to the ‘present speaker’ in the list. In some embodiments, the name of the current speaker may be displayed as the first call member 12 in the list of participating call members 12. In other embodiments, the current speaker is identified via alternative methods, such as flashing the name of the current speaker, placing a symbol next to the current speaker's name, etc.

Accompanying Text Messages; During the teleconference, text messages may be created by call members 12. Some of the message may be of public nature, while others may be private. Public messages may include, inter alia, formal messages such as meeting-minutes or action items. Private message may include among other things, chats between participants. For each message the following information may be saved:

Type; SMS, WAP, etc.

Author

Audience; who was the message sent to

Timestamp

Context; if provided, discussion or chat thread

Cameras (optional); For each camera

Name; the location or person photographed

url or ip address

userid and password

Type; still images or video

Call members 12 may decide which part(s) of the conference XML-based information to concentrate on, and which part(s) to display. Depending on the available display, conference XML-based information may be presented in parallel or only one part at a time.

In some preferred embodiments, depending on the associated calling devices, changes to the teleconference information may be ‘pushed’ to the call members 12 as events. In particular, SMS or WAP-push messages may be used to send these events to the call members 12. Thus, via messages, and without the necessity of running a dedicated application, the present invention may be provided to cellular phone users.

Please refer now to FIG. 2, an illustration of a lifetime diagram 50, constructed according to a preferred embodiment of the present invention.

When teleconferences are critical, it may be important to record the teleconference. It may be equally important to be able to identify, at any particular time, the current speaker. Thus, service 24 may save the ongoing dominant speaker identity. In alternative embodiments, call change information may be stored with the recorded voice. Alternatively, event information may be stored with the recorded voice.

The above alternative storage methods may enable “smart” replay. A user may chose to listen to just one call member 12, to replay from any position, and/or to perform statistics and analysis on all the calls. In alternative embodiments, call member 12 may request lifeline diagram 50 of the teleconference.

Lifeline diagram 50 may be a two-dimension dynamic graph representing the participation of call members 12 at any point in time of the teleconference. Lifeline diagram 50 may be used either in real-time or in playback.

Lifetime diagram 50 may comprise call lifelines 52 and time blocks 54. Each lifeline 52 may be associated with a call member 12. Time block 54 may comprise the identify and recording for the dominate speaker for that associated time.

Lifeline diagram 50 may conveniently enable viewing of call members 12 participated at any specific time. When viewing the lifeline diagram 50 with a Mobil Information Device (MID) or other device with a limited viewing area, the lifeline diagram 50 may “bubble” the active lifelines 52 to the top of lifeline diagram 50. Consequently, the top lifelines 52 in diagram 50 may be the most active ones. In preferable embodiments, at any time during the teleconference, the top lifeline 52 is the current speaker.

In a limited viewing device, such as a small cell phone, bubbling up the lifelines 52 may be critical because the display may not be large enough to show all or most of the conference participants. If the bubbling is not active, the user will not be able to benefit from all the information available in lifeline diagram 50.

Lifeline 52 may be active when the telephone line of the associated call member 12 shows activity. One lifeline 52 may be more active than an other if (1) one lifeline 52 is active more time then the another lifeline 52, or (2) if no lifeline 52 is active, than the lifeline 52 that was active last remains active.

Lifeline diagram 50 may also be interactive. When activated, time block 54 may play a recording of the associated dominant speaker for that relevant time block. Alternatively, when a speaker block 52 is activated, a recording of the associated call member 12 may be heard. Lifeline diagram 52 may provide a powerful tool to analyze and thoroughly understood the teleconference.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A teleconferencing system for a teleconference, the system comprising:
a service for receiving a multiplicity of events via a telephone switch communicating via a plurality of phone lines with a plurality of calling devices; and
a conference information center for receiving said events from said service, and for sending messages pertaining to said events to a plurality of displays, each said display associated with one of said calling devices.

2. The teleconferencing system of claim 1, wherein said events include one or more of the following: call member joined teleconference, call member left teleconference, call member speaking, call member is dominant speaker, change of topic, schedule change, and request to be speaker.

3. The teleconferencing system of claim 1, and further comprising:
a conferencing bridge in communication with said telephone switch, said conferencing bridge for mapping each of said plurality of phone lines to an associated call leg; and
upon occurrence of an event on one of said phone lines, for associating said event with one of said call legs and for notifying said service of said event and associated call leg.

4. The teleconferencing system of claim 3, and further comprising:
a voice activity device for detecting voice activity, for associating said activity with one of said plurality of telephone lines, and for notifying said conference bridge of said activity and said associated phone line.

5. The teleconferencing system of claim 1, and further comprising:
a participant identification module in communication with said service, said participant identification module for associating each of a plurality of users with one of said plurality of phone lines; and
a participant device mapping module in communication with said service, said participant device mapping module for mapping said plurality of calling device;
wherein upon notification of an event, said service associates said event with a user, and notifies said conference information center of said event and said associated user.

6. The teleconferencing system of claim 1, and wherein said conference information center comprises:
conference information, wherein said conference center sends text messages pertaining to said conference information to said displays.

7. The teleconferencing system of claim 5, wherein said conference information includes one or more of the following items: Invitees name; invitee affiliation;
invitee job title; invitee static picture; invitee video image; status of invitees—missing, attending, speaking, presenting, mediating; agenda; title of topics;
planned duration of topics; actual duration of topics; presenter of topic; topic supporting material; topic decisions; speakers list; past, present and future speakers; current speaker; text messages may be created by said users during said teleconference; type of message, author of message, and audience to whom message was sent.

8. The teleconferencing system of claim 1, and further comprising:
a recorder for recording said teleconference, said recorder in communication with said service, said service for associating periods of said recording with events, and for allowing replay of said recording according to said associated events.

9. The teleconferencing system of claim 1, wherein said plurality of calling devices comprises a messaging module, wherein during said teleconference, said messaging module sends messages to one or more other said calling devices.

10. The teleconferencing system of claim 1, and further comprising:
a dominant speaker detector in communication with one or more of said calling devices, said dominant speaker detector for detecting a dominant speaker among two or more speakers using said calling device, and for notifying said service who is said dominant speaker.

11. A method for teleconferencing, the method comprising the steps of:
during a teleconference, receiving a multiplicity of events from a telephone switch communicating via a plurality of phone lines with a plurality of calling devices; and
sending messages pertaining to said events to a plurality of displays, each said display associated with one of said calling devices.

12. The teleconferencing method of claim 11, wherein said first step comprises the step of receiving said multiplicity of events in a service execution environment.

13. The teleconferencing method of claim 11, and further comprising the steps of:
mapping each of said plurality of phone lines with an associated call leg; and
upon occurrence of an event on one of said phone lines, associating said event with its associated call leg.

14. The teleconferencing method of claim 11, and further comprising the step of:
associating each of a plurality of users with one of said plurality of phone lines;
mapping each of said calling device; and
upon notification of an event, notifying said plurality of users of said event and the user associated with said event.

15. The teleconferencing method of claim 11, and further comprising the step of:
storing conference information; and
sending text messages pertaining to said conference information to said displays.

16. The teleconferencing method of claim 11, and further comprising the step of:
recording said teleconference;
associating periods of said recording with events; and
replaying of said recording with said associated events.

17. The teleconferencing method of claim 11, wherein said plurality of calling devices comprises a messaging module, wherein said messaging module sends messages to one or more other said calling devices during said teleconference.

18. The teleconferencing method of claim 11, and further comprising the step of:
sending data notifications via IP to said calling devices comprising GPRS capabilities; and
displaying on said display associated with said plurality of calling devices a graphical view of speakers and associated period of presentation.

19. A method for displaying participants in a teleconference, the method comprising the steps of:
displaying at least a dynamic list of names of said participants; and
when one of said participants is speaking, indicating that said one participant is currently speaking.

20. The method for claim 19, wherein the step of indicating comprises the step of displaying the name of said speaking participant at the top of said list.

21. A teleconference lifeline, the lifeline comprising
a dynamic list of names of said participants in a teleconference, wherein the name of the current speaking participant is listed at the top of said list.

22. A computer program embodied on a computer-readable medium, the computer program comprising:
a first code segment operative to receive a multiplicity of events via a telephone switch communicating via a plurality of phone lines with a plurality of calling devices; and
a second code segment operative to receive said events and send messages pertaining to said events to a plurality of displays, each said display associated with one of said calling devices.

23. The computer program of claim 22, and further comprising:
a third code segment operative to associate each of a plurality of users with one of said plurality of phone lines;
a fourth code segment operative to map said plurality of calling devices
a fifth code segment operative to associate said event with a user, and notify said second code segment of said event and said associated user.

24. A method of deploying a teleconference system comprising the steps of:
during a teleconference, receiving a multiplicity of events from a telephone switch communicating via a plurality of phone lines with a plurality of calling devices; and
sending messages pertaining to said events to a plurality of displays, each said display associated with one of said calling devices.
